(19) United States
(12) Patent Application Publication
(10) Pub. No.: US 2010/0005948 A1
(43) Pub. Date: Jan. 14, 2010

(54) Hi-hat universal foot pedal lock

(76) Inventor: Brian Romolino, Henderson, NV (US)

Correspondence Address: WEIDE & MILLER, LTD., 7251 W. LAKE MEAD BLVD., SUITE 530, LAS VEGAS, NV, 89128, US

(21) Appl. No.: 12/383,050

(22) Filed: Mar. 18, 2009

Related U.S. Application Data
(60) Provisional application No. 61/079,280, filed on Jul. 9, 2008.

(51) Int. Cl. G10D 13/02

(52) U.S. Cl. 84/422.3

(57) ABSTRACT

The foot pedal lock comprising a swing arm rotatably mounted within a support allows a foot pedal of a hi-hat or other instrument to be quickly and easily locked in position. In one embodiment, the foot pedal lock is attached to the front portion of a foot pedal. The swing arm may be rotated forward such that its locking member or members contact a retaining structure or similar structure attached to the foot pedal's stand. The contact between the swing arm and the retaining structure secure the foot pedal in place. The foot pedal may be unlocked by depressing the foot pedal further so that a arm biasing device may retract the swing arm when to unlock the foot pedal.

### CROSS-REFERENCE TO RELATED APPLICATIONS

This application claims priority to U.S. Provisional Application No. 61/079,280 titled Hi-Hat Universal Foot Pedal Locking Adjuster, filed Jul. 9, 2008.

### BACKGROUND OF THE INVENTION

1. Field of the Invention

The invention relates generally to musical instruments and, more particularly, to a foot pedal locking adjuster for percussion or other instruments.

2. Related Art

As is well known, drums are used in nearly all forms of music. The drum set as it is commonly known may comprise various bass drums, snare drums, cymbals, toms, hi-hats, and other percussion instruments. A drummer utilizes his or her hands and feet to play this collection of percussion instruments. As is also known, the various percussion instruments may be muted, muffled, and struck in various ways to generate various sounds.

In many forms of music, including rock, metal, jazz, and pop, the use of a double bass drum or double foot pedal is common. When playing a double bass drum or double foot pedal, it is difficult or impossible to operate other foot pedals because both the drummers feet are used to play the double bass drum. For example, it would be difficult to lock a hi-hat down via a foot pedal while playing a double bass drum.

Traditional devices have attempted to address this problem by providing various locking mechanisms for a hi-hat. These mechanisms are typically complex mechanical devices with many components. In addition, such mechanisms are not intuitive, requiring a drummer to learn new motions to operate the mechanisms. Some traditional devices require the drummer to lock a hi-hat using his or her hands, such as by striking or moving a locking mechanism into place with a drumstick. These devices shift the problem to the drummer's hands by causing the drummer's hands rather than his or her feet to be occupied with locking a hi-hat.

From the discussion that follows, it will become apparent that the hi-hat universal foot pedal lock of the present invention addresses the deficiencies associated with the prior art while providing numerous additional advantages and benefits not contemplated or possible with prior art constructions.

### SUMMARY OF THE INVENTION

A foot pedal lock for locking a foot pedal of a hi-hat or other instrument in position is provided herein. The foot pedal lock allows a user to quickly and easily lock a foot pedal in place to allow the user's foot or feet to be used to play other instruments. For example, the foot pedal lock may be used to quickly lock a hi-hat in position so that the user may play a double bass drum or double pedal bass drum. The foot pedal lock allows a foot pedal to be locked with a user's foot engaged or near the foot pedal. This allows a foot pedal to be quickly locked. The foot pedal may then be unlocked just as conveniently. For example, the foot pedal lock may be disengaged and the foot pedal unlocked by a downward motion by the user's foot. This allows the foot pedal to be quickly unlocked. In addition, the user's foot is advantageously positioned to operate the foot pedal after it has been unlocked.

Various embodiments of the foot pedal lock are provided herein. In one embodiment, the foot pedal lock comprises a support having one or more support members extending from a base. The base of the support may be configured to mount to a foot pedal, and a pivot may extend from the support members. A swing arm comprising one or more locking members and rotatably mounted to the support by the pivot may also be provided. The swing arm may extend by rotating about the pivot to engage a retaining structure of a foot pedal stand, and retract by rotating about the pivot to disengage the retaining structure. The locking members may comprise an angled top edge to engage the retraining structure of the foot pedal stand. In addition, the swing arm may include a stop in one or more embodiments.

An arm biasing device configured to retract the swing arm may be provided to automatically retract the swing arm. It is contemplated that the arm biasing device may be a spring mounted on the pivot, the spring comprising a first arm in contact with the support and a second arm in contact with the swing arm.

The foot pedal lock may provide a swing arm lock to prevent inadvertent release of the swing arm when a foot pedal is in a locked position. The swing arm lock may comprise a lever and be rotatably mounted to the support by the pivot such that the lever is positioned between the swing arm and the support. An extension assembly extending from a back portions of the swing arm toward the lever may be provided as well as a lock biasing device configured to rotate the lever forward. The force from the lock biasing device which rotates the lever may be applied by the lever to the extension assembly to lock the swing arm in place. The lock biasing device may be mounted to the support, and may be magnetic in one or more embodiments.

In one embodiment, a foot pedal having a foot pedal lock may be provided. The foot pedal may comprise a foot pedal stand having one or more retaining structures, and a foot pedal lock. The foot pedal may be configured as described herein. For example, the foot pedal may comprise a support attached to the foot pedal, a pivot attached to the support, a swing arm comprising one or more locking members, and an arm biasing device supported by the support and configured to retract the swing arm. The swing arm may be rotatably mounted to the support by the pivot whereby the swing arm may extend by rotating about the pivot to engage a retaining structure of a foot pedal stand and retract by rotating about the pivot to disengage the retaining structure.

The swing arm may engage various retaining structures to lock a foot pedal in position. For example, retaining structures may comprise planar structures having a front face and a bottom edge where the bottom edge contacts the locking members of a swing arm when the swing arm in an extended position. In addition, retaining structures may be adjustable or repositionable on the foot pedal stand. The swing arm may also be locked in position by a swing arm lock to prevent inadvertent disengagement, as discussed above.

A method of locking a foot pedal is also provided herein. In one embodiment, the method comprises playing a hi-hat comprising a foot pedal having a foot pedal stand with one or more retaining structures, depressing the foot pedal to move one or more cymbals of the hi-hat, and locking the foot pedal in a locked position with a foot pedal lock. Locking the foot pedal in a locked position with a foot pedal lock may occur by extending a swing arm of the foot pedal lock forward about a pivot until a locking member of the swing arm contacts one of the one or more retaining structures of the foot pedal stand. The swing arm may then be held in an extended position by friction between the swing arm and the retaining structure. In embodiments where the swing arm has a stop, locking the foot pedal of the hi-hat may include extending the swing arm of the foot pedal lock forward about a pivot until a stop of the swing arm contacts one of the one or more retaining structures.

The foot pedal may then be released from the locked position by further depressing the foot pedal to reduce the friction between the swing arm and the retaining structure. The swing arm may then be retracted about the pivot by an arm biasing device, such as the spring discussed above.

The swing arm may be locked according to the method as well. For example, the method may include locking the swing arm in the extended position with a swing arm lock comprising a lever. The swing arm lock may be rotatably mounted to the pivot so that a lock biasing device may rotate the lever of the swing arm lock to contact an extension assembly of the swing arm to lock the swing arm in an extended position. When the swing arm is locked by a swing arm lock, releasing the foot pedal from the locked position may also include rotating the lever of the swing arm lock away from the extension assembly to unlock the swing arm before the arm biasing device retracts the swing arm unlocking the foot pedal.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a perspective view of an exemplary hi-hat with an embodiment of the foot pedal lock;

FIG. 2A is a perspective view of an exemplary foot pedal lock on a foot pedal;

FIG. 2B is a side view of an exemplary foot pedal lock in an extended position;

FIG. 3 is a perspective view of an exemplary support;

FIG. 4 is a perspective view of an exemplary swing arm;

FIG. 5 is a perspective view of an exemplary arm biasing device in an embodiment of the foot pedal lock;

FIG. 6A is a perspective view of an exemplary foot pedal stand;

FIG. 6B is a perspective view of an exemplary retaining structure;

FIGS. 7A-7C are side views of an exemplary foot pedal lock in operation;

FIG. 8 is a perspective view of an exemplary foot pedal lock having a swing arm lock;

FIG. 9 is a perspective view of an exemplary support;

FIG. 10 is a perspective view of an exemplary swing arm lock;

FIG. 11 is a perspective view of an exemplary swing arm having an extension assembly;

FIG. 12 is a perspective view of an exemplary swing arm lock in an embodiment of the foot pedal lock;

FIGS. 13A-13C are side views of an exemplary foot pedal lock having a swing arm lock in operation; and

FIG. 14 is a perspective view of an exemplary swing arm lock in an embodiment of the foot pedal lock.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The foot pedal lock herein provides numerous advantages. In particular, the foot pedal lock may be used to control the spacing or gap between an upper and lower cymbal of a hi-hat. If the gap between the cymbals is adjusted to become wider or narrower, the resonance frequency of a hi-hat can be changed to provide a different sound. As is known, if the gap is closed, the cymbals produce a more click type sound whereas the cymbals will ring if struck when the gap is open.

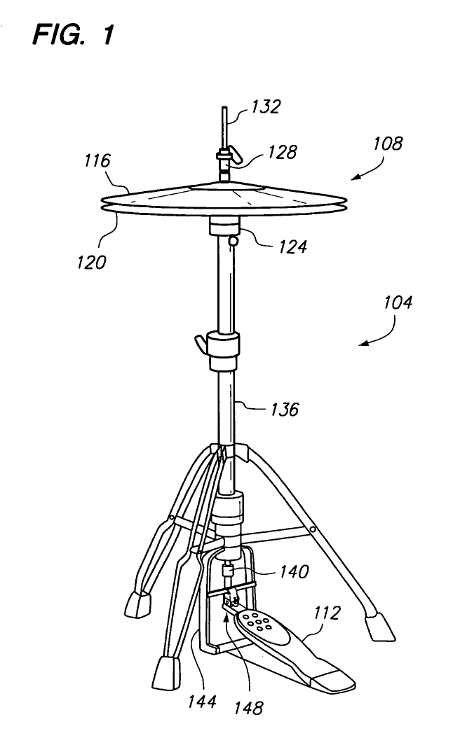

FIG. 1 illustrates a traditional cymbal stand 104 having a foot pedal 112 and a hi-hat 108. A foot pedal lock 148, which will be described further below, may be attached to a portion of the foot pedal 112. In one or more embodiments, the foot pedal lock 148 contacts a retaining structure, such as on a foot pedal stand 144, to lock the foot pedal 112 in position. The hi-hat 108 comprises an upper cymbal 116 and a lower cymbal 120. As can be seen, a bearer unit 124 is usually provided to hold the lower cymbal 120 in place. Another bearer unit 128 locked to a positioning rod 132 holds the upper cymbal 116 on the positioning rod. The positioning rod 132 extends through a cymbal support 136 of the cymbal stand 104 so that it may be attached to the foot pedal 112 by a linkage 140. As is known, the linkage 140 may be a chain, wire, or other rigid or non-rigid structure capable of connecting the positioning rod 132 to the foot pedal 112.

As can be seen, movement of the foot pedal 112, such as depressing the foot pedal, moves the positioning rod 132 within the cymbal support 136 which causes the upper cymbal 116 to move accordingly. The hi-hat 108 may thus be played, opened, and closed by moving the upper cymbal 116 with the foot pedal 112.

In typical cymbal stands 104, the positioning rod 132 or foot pedal 112 may be spring loaded such that the foot pedal returns to an undepressed position after being depressed, such as shown in FIG. 1. The spring automatically opens the hi-hat (such as by returning the foot pedal 112 to an undepressed position or moving the positioning rod 132 upward).

The foot pedal lock 148 herein may be used to prevent the hi-hat 108 from opening when such opening is not desired. For example, a user may desire the closed sound of a hi-hat 108 for certain parts of a song. As is known, this type of sound can only be generated by closing the hi-hat's 108 upper and lower cymbals 116,120 such that the upper and lower cymbals are in contact with one another.

The foot pedal lock 148 also may be used to lock a hi-hat 108 at other than a fully closed position. As is known, different hi-hat sounds may be generated as the upper and lower cymbals 116,120 move closer or further apart. The foot pedal lock may be used to lock the upper and lower cymbals 116,120 at a closer position than their current position. This is advantageous when such different hi-hat sounds are desired for certain parts of a song. This is also advantageous because this closer position of the upper and lower cymbals 116,120 is difficult to quickly achieve with traditional hi-hats. This is because the upper cymbal 116, lower cymbal 120, or both must be positioned in the desired closer position by hand or the foot pedal 112 must be held in place by the user at a position to achieve the desired separation of the cymbals. This is difficult or impossible when playing the drums. [PLEASE CONFIRM ACCURACY OF ABOVE]

As will be described further below, the foot pedal lock 148 may comprise a universal foot pedal lock in that it can be configured for use with various foot pedals. For example, the foot pedal lock 148 may be used with various brands or configurations of foot pedals for hi-hats. The configuration of the foot pedal lock 148 does not require complex mechanisms to achieve foot pedal locking. As stated above, traditional locking mechanisms include numerous components which must be attached to multiple components or locations of a cymbal stand. Further, these locking mechanisms are cumbersome to use and can be unreliable due to their complexity. It is noted that the foot pedal lock may be included or provided as part of a foot pedal in one or more embodiments.

It is noted that the foot pedal lock 148 may be used with foot pedals for various instruments in one or more embodiments. For example, a foot pedal lock 148 may be used with the foot pedal of a bass or other drum to lock its mallet in place. This may be advantageous where a user wants to lock the head of a mallet against the bass drum to mute or muffle the bass drum. [PLEASE CONFIRM ACCURACY] Of course, the foot pedal lock 148 may be used with other instruments to lock their foot pedals as well.

The foot pedal lock's 148 ease of use allows a user to quickly lock a foot pedal and continue playing. In fact, the foot pedal lock 148 may be operated entirely hands-free. As will become apparent from the discussion below, a user may operate the foot pedal lock 148 with his or her foot or toes. This ease of use is highly advantageous in that a user is able to keep rhythm while switching between a locked and unlocked foot pedal. This is especially so in the case where a drummer must lock a hi-hat foot pedal to shift foot positions to play a double bass drum or double pedal bass drum.

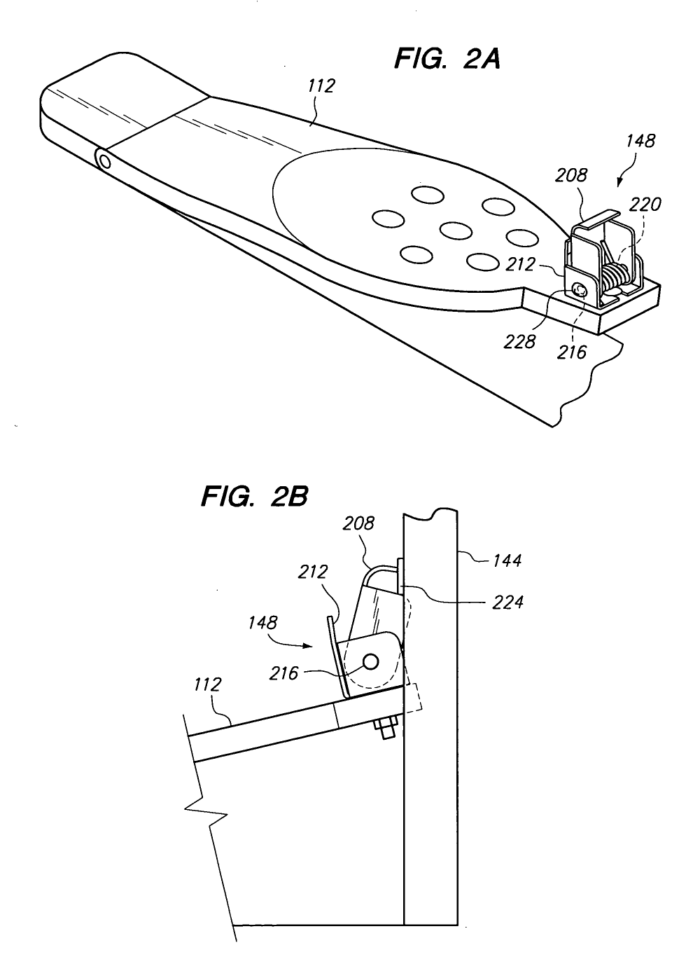

The foot pedal lock 148 will now be described with regard to FIGS. 2A and 2B. FIG. 2A illustrates an exemplary foot pedal lock 148 attached to a foot pedal 112. The foot pedal lock 148 will typically be located at the front or toe portion of a foot pedal 112, and may be oriented such that a foot pedal lock's swing arm 208 may rotate forward from the front of a foot pedal 112. This allows the swing arm 208 to make contact with a retaining structure 224 to hold or lock a foot pedal 112 in place, as shown in FIG. 2B. As will be described further below and illustrated in FIG. 2A, one or more arm biasing devices 220 which cause the swing arm 208 to automatically retract may also be provided.

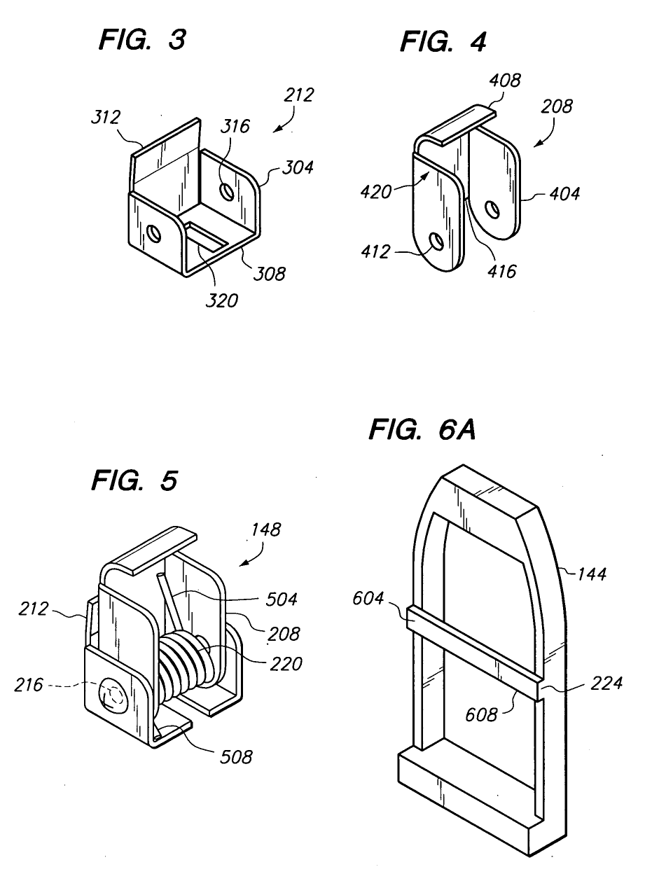

In one or more embodiments, the swing arm 208 may be secured within a support 212. In general, the support 212 of the foot pedal lock 148 provides a structure to which the swing arm 208 may be mounted that allows the swing arm to rotate or otherwise extend. The support 212 may be configured in various ways. As shown in FIG. 3 for example, the support 212 comprises a base 308 and two support members 304. The support 212 may also comprise a back 312 in some embodiments.

In one or more embodiments, the base 308 may be used to mount the foot pedal lock to a foot pedal. For example, the base 308 of the support 212 may include one or more openings 320 to allow the support 212 to be attached to a foot pedal 112. A fastener may be inserted into the one or more openings 320 of the base 308 and into and/or through a portion of a foot pedal to secure the support to the foot pedal. As will be understood, a variety of fasteners may be used including, but not limited to, screws, nuts, bolts, pins, rivets, or the like.

In some embodiments, the support 212 may be formed integral with a foot pedal. In such embodiments, one or more openings 320 may not be provided. The support 212 may also be welded, adhered, or otherwise bonded to a foot pedal. For example, the base 308 of a support may be bonded to a foot pedal. Of course, the foot pedal lock may also be attached to an existing foot pedal such as to retrofit an existing foot pedal with locking capabilities. It is noted that the base 308 may include one or more guides which allow it to be accurately positioned on a foot pedal. For example, the base 308 may have one or more downward extending tabs which help properly position the base on a foot pedal so that the support 212 may be properly attached.

The back 312 of the support may extend from the base 308. The back 312 is beneficial in that it keeps the swing arm in a substantially upright position when retracted, as can be seen in FIG. 2A. In one or more embodiments, without the back 312, the swing arm may be retracted past this upright position by the arm biasing device. A back 312 is not required in all embodiments however. For example, as will be described further below, the swing arm may comprise one or more extensions which prevent the arm biasing device from retracting the swing arm past a substantially upright position.

One or more support members 304 of the support 212 may extend upward from the base 308 in one or more embodiments. This allows a support member 304 to support a pivot which allows the swing arm to extend and retract. As shown in FIG. 2A for example, the pivot 216 extends from a first support member to the second support member of the support 212. Though shown as having two support members 304, a support 212 may utilize a single support member to support a pivot in some embodiments. It is contemplated that the support members 304 may have one or more openings 316 or the like to accept the pivot. It is noted that, in one or more embodiments, the support members 304 may also guide the motion of the swing arm as it rotates. For example, a support member 304 may provide a planar surface that can guide the motion of a swing arm as it rotates.

The pivot 216 will now be described with regard to FIGS. 2A and 2B. In general, the pivot 216 allows the swing arm 208 to rotate and thus extend and retract. As shown for example, the pivot 216 may be an elongated cylindrical member which extends through the swing arm 208 to allow this rotation. It is noted that a pivot 216 may comprise other structures in some embodiments. For example, the swing arm 208 may be rotatably by a pivot comprising a hinge attached to the base or support member of the support 212 in one or more embodiments. Also, a pivot 216 may be supported by the base, one or more support members, or both in some embodiments.

The pivot 216 may be comprise various shapes if desired. For example, a non-cylindrical shaped portion of the pivot 216 may be used to lock the pivot to a swing arm 208 or a support 212. In these embodiments, the swing arm 208 may rotate relative to the support 212 via the cylindrical portion(s) of the pivot 216. To illustrate, in one embodiment, the ends of a pivot 216 may be rectangular. The support 212 in this embodiment may have rectangular openings in its support members to accept the pivot 216. The rectangular shape may be used to hold the pivot 216 in position relative to the support 212. The central portion of the pivot may then be circular to allow the swing arm 208 to rotate. It will be understood that the circular portions of the pivot 216 may also be at its ends while a rectangular (or other shaped) shaped section forms a central portion of the pivot 216.

The pivot may be secured to a support 212 in various ways. As shown in FIG. 2A for example, the pivot 216 extends through openings in the support members of a support. At least a portion of the pivot 216 may be threaded to allow the pivot to be secured by a corresponding threaded fastener, such as a nut or other threaded structure. For example, one or both ends of the pivot 216 may be threaded to allow the pivot to be secured by one or more threaded connectors. It is noted that the opening in a support member of a support may itself be threaded to secure the pivot 216. In the embodiment of FIG. 2A, the pivot 216 comprises a threaded portion and an enlarged head 228. The enlarged head 228 secures one end of the pivot 216 while its other end may be secured by a threaded connector. This is beneficial in that the pivot 216 can be removed such as for replacement, maintenance, or repair. It is noted that the pivot 216 may also or alternatively be secured by welding, adhering, or otherwise bonding the pivot to the support 212 if desired.

In some embodiments a plurality of pivots 216 may be provided. Also, the pivot 216 may not extend all the way from the first to the second support member of a support 212. For example, two pivots 216 may be provided at each support member of a support 212, where each pivot supports a side of the swing arm 208.

The swing arm 208 will now be described with regard to FIG. 4. As stated, a swing arm 208 is preferably a structure configured to extend and contact a retaining structure to lock a foot pedal in place. In one or more embodiments, the swing arm 208 may comprise a back 416 and one or more locking members 404 which contact a retaining structure to lock a foot pedal in place, as will be described further below. The back 416 of the swing arm 208 or a portion thereof will typically extend above the support of the foot pedal lock. This can be seen in FIG. 2A. This height allows a user to contact and thus rotate the swing arm 208 forward.

A locking member 404 may extend outward from the back 416 of the swing arm 208. For example, a locking member 404 may extend substantially perpendicular from the back 416 of the swing arm as shown in FIG. 4. It is noted that a locking member 404 may extend at various angles from the back 416 as well. In one embodiment, a locking member 404 extends from either or both sides of the back 416. However, it will be understood that one or more locking members 404 may extend from various portions of the swing arm's back 416. In embodiments, with a single locking member 404, the locking member may extend from a central portion of the back 416 or from other locations on the back.

A bottom portion of each locking member 404 may be rounded, tapered, or the like if necessary to allow the swing arm 208 to rotate within the support 212. In addition the bottom portion of each locking member 404 may be shaped to prevent an arm biasing device from rotating a swing arm 208 beyond a generally upright position. For example, each locking member 404 may have an angled bottom portion which allows forward rotation of the swing arm, but prevents backward rotation by contacting a portion of the support, foot pedal, or other structure. It is noted that the back 416 of the swing arm 208 may also be configured to prevent the swing arm 208 from retracting beyond an upright position. For example, as will be described below, the back 416 may comprise an extended portion or an extension assembly which contacts the support, foot pedal, or other structure during retraction of the swing arm 208.

The locking members 404 may be configured to utilize friction to keep the swing arm 208 in contact with a retaining structure despite the force of the arm biasing device that would otherwise retract the swing arm. The locking members 404 may include a top edge 420 that allows the swing arm 208 to engage a variety of retaining structures, allowing the foot pedal lock to be used with a variety of foot pedals. The top edge 420 may be perpendicular to the back 416, sloped, or angled in one or more embodiments. For example, a top edge 420 of a locking member 404 may be angled down towards the bottom of the swing arm 208 in one or more embodiments. It is contemplated that the top edge 420 may also include one or more curves in addition to or instead of angled portions. The top edge 420 may also have a textured surface to provide additional grip when in contact with a retaining structure.

In one or more embodiments, the swing arm 208 also includes one or more openings 412 in the locking members 404. These openings 412 may be configured to accept a pivot 216 as described above. As can be seen from the assembled embodiment of FIG. 2A, the openings allow the swing arm 208 to be secured by a pivot 216 within a support 212 while allowing the swing arm to rotate about the pivot.

The swing arm 208 may also comprise a stop 408 which physically prevents the swing arm from rotating too far forward. In general, the stop 408 prevents movement or rotation of a swing arm 208 by physically contacting another structure. For instance, FIG. 2B illustrates a stop 408 preventing further forward movement of the swing arm 208 because it has come into contact with a retaining structure 224.

Referring back to FIG. 4, a stop 408 is beneficial in that it prevents the swing arm 208 from becoming jammed making it difficult to retract the swing arm (to unlock a foot pedal) when desired. The stop 408 also allows a user to know that the swing arm 208 has been properly engaged to lock the foot pedal. This is because the user can feel that the swing arm 208 cannot be moved or rotated any further forward.

The stop 408 may extend outward from the back 416 of the swing arm 208. As shown for instance, the stop 408 extends outward from a top portion of the swing arm's back 416. Typically, the stop 408 will not extend beyond the locking members 420 to allow the locking members 420 to contact a retaining structure. It is noted that though shown in a generally planar configuration, the stop 408 may have various shapes.

FIG. 5 illustrates an exemplary arm biasing device 220 which provides a force that retracts the swing arm 208 from an extended position back to a retracted position. Likewise, the arm biasing device 220 also keeps the swing arm 208 in a retracted position until the swing arm is extended forward by a user. An arm biasing device 220 may comprise a resilient member or structure, such as a spring or elastic band, and may be mounted between the swing arm 208 and the support 212. In this manner, rotating the swing arm 208 forward deforms an arm biasing device 220 while releasing the swing arm allows the arm biasing device to retract the swing arm. It is contemplated that one or more magnets may also be used as arm biasing devices 220 as well.

As shown, the arm biasing device 220 comprises a spring having a first and second arm 504,508. A portion of the spring is coiled around the pivot 216. The first arm 504 contacts a portion of the spring arm 208 while the second arm 508 contacts a portion of the support 212. In this manner, the arm biasing device 220 provides resistance to the forward rotation of the swing arm 208 and also retracts the swing arm back.

Resistance to the forward rotation provided by the arm biasing device 220 is beneficial in that it helps prevent the swing arm 208 from inadvertently rotating forward and locking a foot pedal in place. The retraction force provided by the arm biasing device 220 is beneficial in that it allows a drummer to easily unlock a foot pedal. For example, depressing a locked foot pedal will release the friction between a swing arm 208 and a retaining structure, thus allowing the arm biasing device 220 to automatically retract the swing arm.

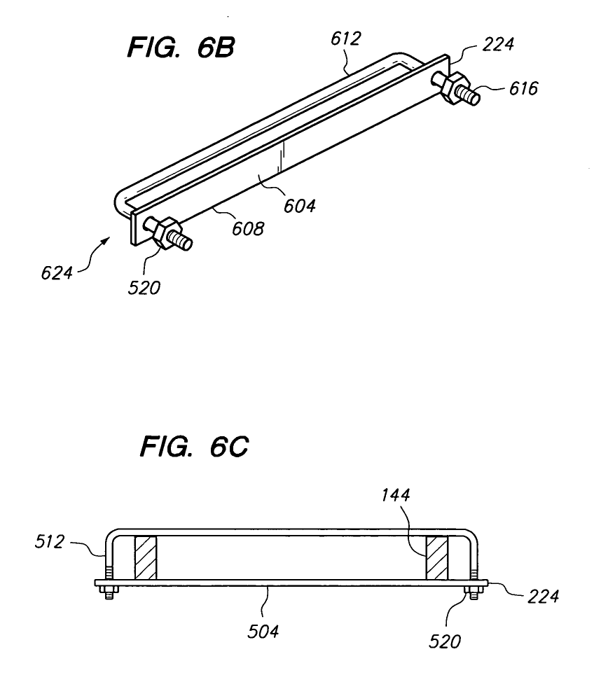

The retaining structure 224 will now be described with regard to FIG. 1 and FIGS. 6A-6C. In general, a retaining structure 224 provides a surface which the locking members of a swing arm may contact. The friction between the swing arm and retaining structure 224 allows the swing arm to be held in an extended position as shown in FIG. 2B. The retaining structure 224 may be an attached structure or integrally formed with a hi-hat or other stand or structure as will be described further below. It will be understood that various structures may serve as a retaining structure 224. For this reason a discrete retaining structure 224 need not be provided in all embodiments. For example, a foot pedal stand 144, hi-hat stand, or both may already have a structure or surface that may be used to perform the function of a retaining structure. To illustrate, a foot pedal stand 144 may have a member or protrusion which allows a locking member of the foot pedal lock's swing arm to secure a foot pedal in a depressed position.

FIG. 6A illustrates an exemplary retaining structure 224 for attachment to a foot pedal stand 144. In this embodiment, the retaining structure 224 may be attached at a central location on the foot pedal stand 144. Of course, a retaining structure 224 may be attached at other locations on a foot pedal stand 144. In addition, a retaining structure 224 may have an adjustable position in one or more embodiments. This adjustability allows the foot pedal lock to be used with a variety of foot pedals. In addition, the adjustability allows the foot pedal lock to lock a foot pedal at different positions. This is advantageous in that it allows the user to lock the upper and lower cymbals of a hi-hat at various distances from one another.

As shown, the retaining structure 224 is substantially planar and extends from one side of the foot pedal stand 144 to the other. The retaining structure 224 may comprise a front face 604 and bottom edge 608 which provide points of contact for the stop and the locking members of the foot pedal lock's swing arm, respectively. This can be seen in FIG. 2B.

The retaining structure 224 may be attached to a foot pedal stand 144 in various ways. In FIG. 6A for example, the retaining structure 224 may be integrally formed, adhered, welded or otherwise bonded to the foot pedal stand 144. A retaining structure 224 may also be attached by one or more fasteners. For example, one or more screws, rivets, pins, clips, clamps, or the like may be used. In one embodiment, a series of threaded or other holes may be made or provided in a foot pedal stand 144 to allow a retaining structure's 224 position to be adjusted.

FIG. 6B illustrates a retaining structure assembly 624 which allows a retaining structure 244 to be attached to various foot pedal stands 144 or other structures. This allows the retaining structure 224 both to be attached to various foot pedal stands 144, and to be adjustably positioned on a foot pedal stand.

In one or more embodiments, the retaining structure assembly 624 comprises a clamping bar 612 having threaded ends 516, a retaining structure 224 having openings corresponding to the threaded ends, and fasteners 520 for the threaded ends. The clamping bar 512 may have a “U” shape large enough to fit around a portion of a foot pedal stand 144 such as shown in the top cross section view of FIG. 6C. The retaining structure 224 of the assembly 524 may have one or more openings to accept the threaded ends 516. In this manner, the retaining structure 224 may be adjustably secured in place by one or more fasteners 520. In this case, the fasteners 520 are threaded nuts which may be tightened over the threaded ends 516 of the clamping bar. Of course, other threaded fasteners may be used.

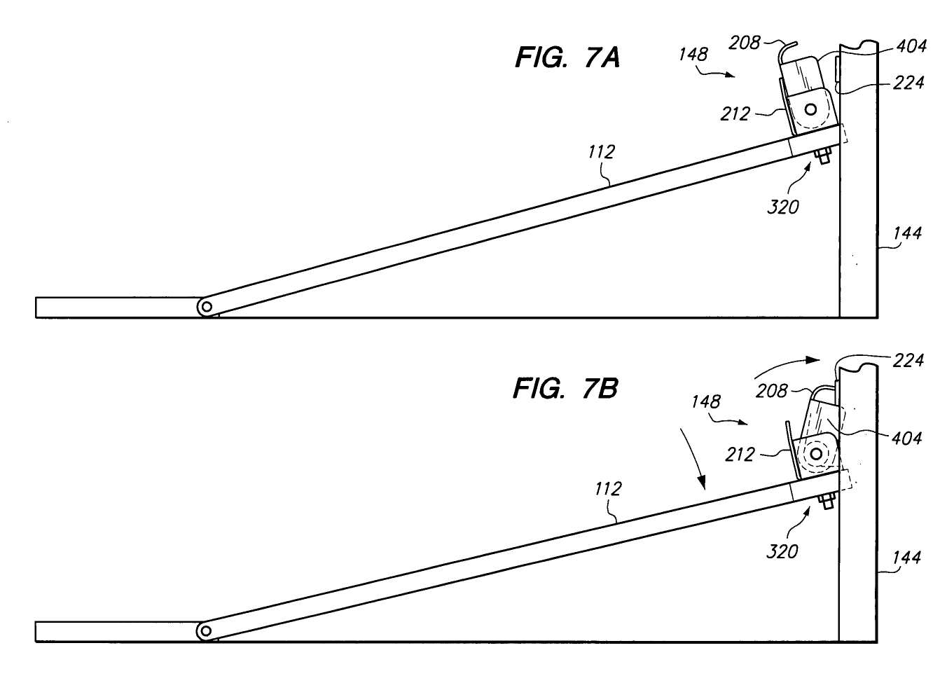

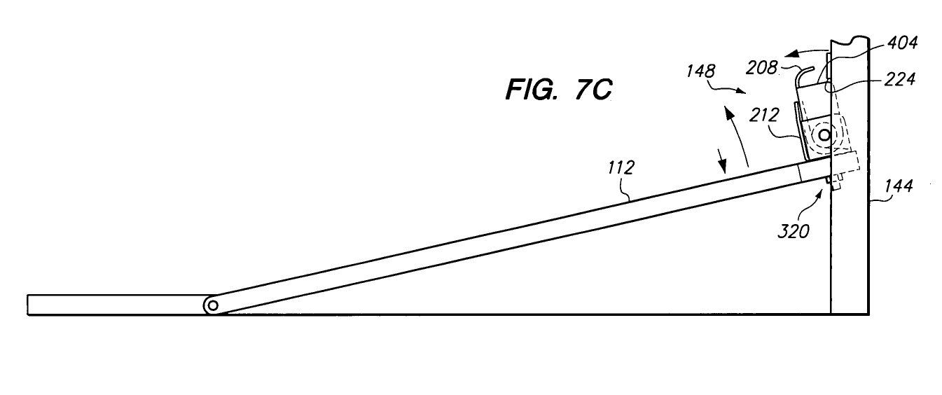

Operation of the foot pedal lock will now be described with regard to FIGS. 7A-7C. FIG. 7A illustrates a foot pedal 112 in an unlocked and undepressed position. Also, in this figure, the swing arm 208 of the foot pedal lock 148 is in a retracted position. As described above, an arm biasing device may be used to keep the swing arm 208 in a substantially retracted position while the foot pedal 112 is in use. It can be seen from FIG. 7A, that the foot pedal 112 may be used normally (i.e. like a traditional foot pedal) even with the foot pedal lock 112 installed.

In FIG. 7B, the user desires to lock the foot pedal 112 in a depressed position. As stated, in the case of a hi-hat, locking the foot pedal 112 in a depressed position moves the upper cymbal closer to the lower cymbal or closes the hi-hat. This allows the hi-hat to generate different sounds. With the foot pedal lock 148 securing the foot pedal 112 in place, the user's foot is free for other tasks. For example, the user now has at least one foot free to play another foot pedal. In one situation, this would allow the user to play a double bass drum or double pedal bass drum, while the hi-hat is locked in position.

To lock the foot pedal 112, the user may rotate the swing arm 208 of the foot pedal lock 148 forward to an extended position where the locking members 404 of the swing arm contact a retaining structure (or other suitable structure as described above). For example, the user may utilize his or her foot, or a front portion thereof, to rotate the swing arm 208. As can be seen, the locking members 404 contact the retaining structure 224 and are held in place by friction between the retaining structure and the locking members. As is known, most foot pedals 112 will bias upward. This upward force from the foot pedal 112 helps generate friction between the retaining structure and locking members to keep the locking members in place.

The upward force from the foot pedal 112 may be supplemented in some embodiments if necessary. For example, the foot pedal 112 itself may not generate sufficient upward force to create the necessary friction to hold the swing arm 208 in an extended position. If this were to occur, the swing arm 208 would automatically retract by the force of its arm biasing device. Thus, in some embodiments, an additional spring or the like may be used to supplement the upward force of a foot pedal 112. In one embodiment, an additional spring may be placed under the foot pedal 112 to accomplish this.

If the swing arm 208 comprises a stop 408, the stop will prevent the swing arm from rotating past a certain point which lets the user know the foot pedal 112 has been locked in position. As stated above, the stop 408 may also prevent the locking members 404 of a swing arm 208 from becoming lodged or wedged in place which may cause the foot pedal 112 to become difficult to unlock.

In FIG. 7C, the user has unlocked the foot pedal 112. This may be accomplished by further depressing the foot pedal 112. As can be seen from FIGS. 7B and 7C, further depressing the foot pedal 112 reduces the friction between the locking members 404 and the retaining structure 224. If depressed far enough, the locking members 404 and retaining structure 224 may no longer be in physical contact. In either case, once this occurs, the arm biasing device of the foot pedal lock 148 will rotate the swing arm 148 back to a retracted position unlocking the foot pedal 112 such as shown in FIG. 7A. The foot pedal 112 may then be used or played normally.

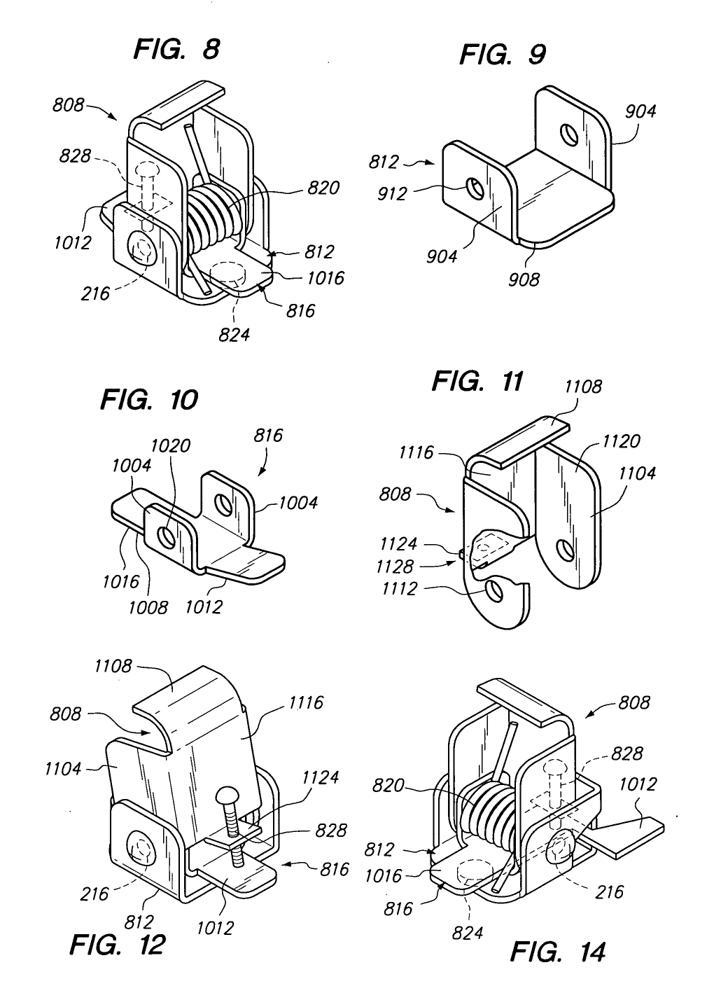

It is contemplated that the foot pedal lock may be configured in other ways. For example, as shown in FIG. 8, the foot pedal lock 148 may be configured to include a swing arm lock 816. The swing arm lock 816 may be configured to hold a swing arm in place during drumming. To illustrate, vibration from drumming, may, in some situations, cause a swing arm to inadvertently release. This would cause a locked pedal and cymbals to be inadvertently released as well. As will be described further below, the swing arm lock 816 applies a force to the swing arm that assists in keeping the swing arm extended.

An exemplary embodiment of the foot pedal lock having a swing arm lock 816 will now be described with regard to FIGS. 9-12. It will be understood that like elements of the foot pedal lock may comprise one or more similar features in the various embodiments of the foot pedal lock described herein. FIG. 9 illustrates a support 812 without a back. As shown, the support comprises two side support members 904 extending upward from a base 908. The side support members 904 may have one or more openings 912 to allow passage of a pivot 216 therethrough. A portion of the base 908 may extend further than the side support members 904 to provide an area to support one or more lock biasing devices 824, such as the magnet as shown in FIG. 8.

In general, a lock biasing device 824 provides a force which holds or helps to hold the swing arm of the foot pedal lock in an engaged position as will be described further below. It is noted that one or more lock biasing devices 824 may be located at various locations on the base 908. Various devices may be used to generate such a force including but not limited to magnets, springs, or elastic bands. Where magnetism is used to generate this force, the base 908, the pedal release 816, or both may itself be magnetic or magnetized. Where magnetized, the magnetized portion of the base 908 or the swing arm lock 816 may form the lock biasing device 824.

The swing arm lock 816 will now be described with regard to FIG. 10. As shown, the swing arm lock 816 comprises two flanges 1004 extending upward from a lever 1008. The lever 1008 may have one or more angles along its length such as shown or be substantially straight. The lever 1008 may comprise a user engageable portion 1012 at its front end to allow a user to move the swing arm lock 816 to release the foot pedal lock. A second portion 1016 of the lever 1008 may be used to lock a swing arm in place through physical contact with a portion of the swing arm, as will be described further below. It is noted that the swing arm lock 816 may be configured with a different user engageable portion 1012.

For example in FIG. 14, the user engageable portion 1012 of the swing arm lock 816 may extend towards a user through a side opening or portion of a support. The user engageable portion 1012 may have different shapes and sizes to allow the user to easily engage and thus operate the swing arm lock 816. For instance, as shown in FIG. 14, the user engageable portion 1012 has an elongated shape which allows a user to operate the swing arm lock 816 easily and conveniently.

Referring back to FIG. 10, the flanges 1004 may include one or more openings 1020 to accept a pivot 216, as can be seen in FIG. 8. This allows a pivot 216 to secure the pedal release 816 within the foot pedal lock 148. In addition, the pedal release 816 may rotate about the pivot 216 in this manner. The openings 1020 shown are circular in shape, however, it is noted that openings may have other shapes and configurations, such as described above.

FIG. 11 illustrates a swing arm 808 comprising a stop 1108, a back 1116, and locking members 1104. As described above, the stop 1108 extends from a top portion of the back 1116 while the locking members 1104 extend from the sides of the back. The locking members 1104 may comprise one or more openings 1112 to allow passage of a pivot 216 therethrough. In addition, the locking members 1104 may have a top edge 1120 which may be used to frictionally hold the swing arm in an extended position.

The swing arm 808 may comprise an extension assembly 1128. The extension assembly 1128 may provide an extendable portion which allows the swing arm 808 to properly contact the swing arm lock 816. In one embodiment, the extension assembly 1128 may be at the back of the swing arm 808. The extension assembly 1128 may comprise a tab 1124 which holds an tension or adjustment member 828, such as a screw or pin. The adjustment member 828 may be extended or retracted within the tab 1124 to properly contact the swing arm lock 816. For example, an adjustment member 828 comprising a screw may be turned clockwise or counterclockwise to lower and raise the screw. It is noted that the tab 1124 may comprise a clip, clamp, opening, or the like which holds an adjustment member 828 in place but also allows the adjustment member to be moved relative to the tab in one or more embodiments.

FIG. 12 illustrates an assembled foot pedal lock having a swing arm lock 816. A biasing device 820, as can be seen in FIG. 8, is installed around the pivot of the foot pedal lock to retract the swing arm 808, such as described above. In this embodiment, the swing arm lock 816 is positioned between the support 812 and the swing arm 808.

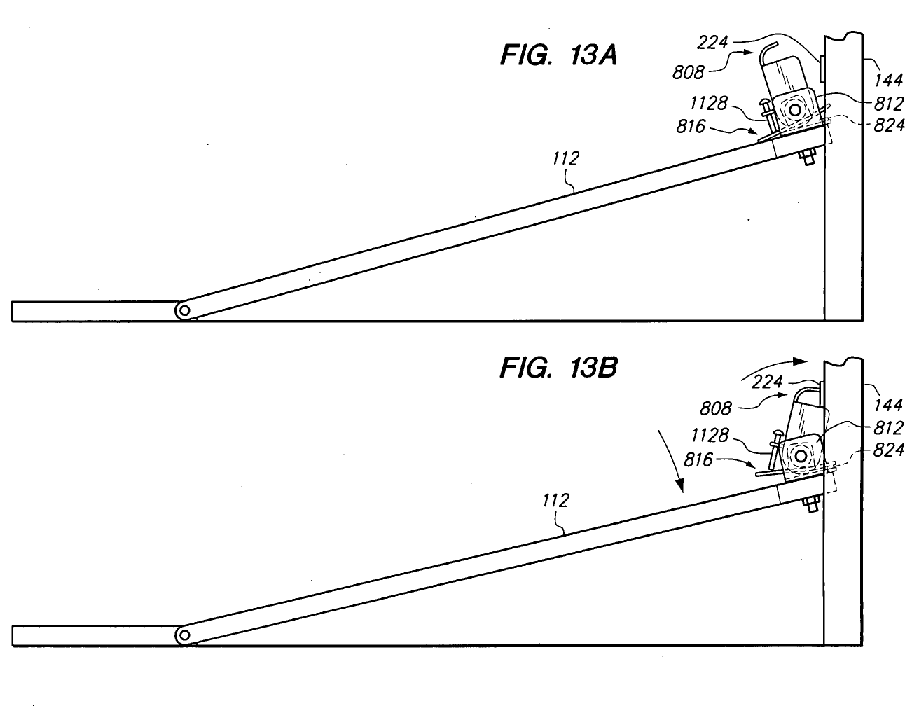

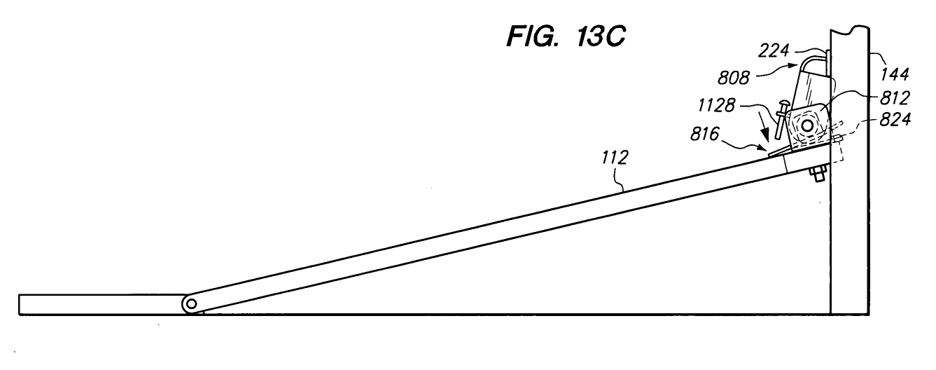

In general, the swing arm lock 816 and the swing arm 808 rotate independently about the pivot 216. In use, when the swing arm 808 is engaged, the swing arm lock 816 may be rotated to apply a force to the swing arm 808 holding the swing arm in an extended position. FIGS. 13A-13C illustrate this.

As shown in FIG. 13A, the swing arm 808 is held in a retracted position by the arm biasing device. The arm biasing device also holds the user engageable portion 1012 of the swing arm lock 816 in place through the extension assembly 1128 of the swing arm 808. This counteracts the force provided by the lock biasing device 824 which would otherwise rotate the swing arm lock 816 forward. To illustrate, it can be seen in FIG. 13A, that the extension assembly 1128 of the swing arm 808 is in contact with swing arm lock 816 which holds the swing arm lock in place.

When foot pedal locking is desired, the swing arm 808 may be rotated to an extended position by the user to engage a retaining structure or other structure, locking a foot pedal in place. The lock biasing device 824, such as the magnet shown, causes the swing arm lock 816 to rotate along with the swing arm 808. The swing arm lock 816 transfers force from the lock biasing device 824 to the swing arm 808 to help keep the swing arm in an extended position.

To illustrate, in FIG. 13B, the swing arm 808 has been extended and is being held in place by friction between the swing arm 808 and the retaining structure 224. The swing arm lock 816 is also applying a force on the swing arm 808 through the extension assembly 1128 of the swing arm. This force keeps the swing arm 808 from inadvertently returning to a retracted position. For example, vibration or other agitation of the foot pedal lock may allow the arm biasing device to inadvertently retract the swing arm 808. The force provided by the swing arm lock 816 pushes the swing arm 808 towards the retaining structure 224 to prevent this from occurring.

When foot pedal locking is no longer desired, the swing arm 808 and swing arm lock 816 may be easily disengaged by a single motion of a user's foot. As shown in FIG. 13C, the swing arm lock 816 may be disengaged by applying force to its user engageable portion 1012 which overcomes the force of the lock biasing device 824. Pressing the foot pedal 112 down further from its current position releases the friction between the swing arm 808 and the retaining structure. This allows the arm biasing device 820 to return the swing arm 808 to a retracted position which unlocks the foot pedal. As can be seen, this may be done in a single motion. For example, a user may press the user engageable portion 1012 of the swing arm lock 816 at the same time or in the same motion as pressing the foot pedal 112. In this manner, the foot pedal lock is disengaged and the foot pedal is unlocked.

It can thus be seen that the extension assembly 1128 is beneficial because it allows the swing arm lock 816 to properly apply force to the swing arm 808 and vice versa. In one or more embodiments, the adjustment member 828 of the extension assembly 1128 may be moved to ensure that proper contact between the swing arm lock 816 and the extension assembly 1128 is maintained. Typically, this means that the adjustment member 828 is positioned such that it holds the swing arm lock 816 in place when the swing arm 808 is in a retracted position, such as described above with regard to FIG. 13A, and that the adjustment member allows the swing arm lock to ensure the swing arm does not inadvertently retract when the swing arm is in an extended position as shown in FIG. 13B.

Though beneficial, it is contemplated that the extension assembly 1128 may not be adjustable in all embodiments. For example, the extension assembly 1128 may be a solid or fixed structure which extends from the back of the swing arm 808. In one embodiment, the extension assembly 1128 may be fixed where the foot pedal lock is integral with or designed for a particular foot pedal. Of course, the extension assembly 1128 may be fixed or adjustable in various embodiments of the foot pedal lock.

As can be seen the foot pedal lock allows a foot pedal to be quickly and easily locked in place. The foot pedal lock's position on a foot pedal allows locking and unlocking to be achieved by a users foot. In addition, the close proximity of the foot pedal lock to a user's foot or feet allow a foot pedal to be quickly locked. This is highly advantageous especially where the user is playing at a fast pace. Further, the foot pedal lock can be quickly unlocked, also by a user's foot. Due to the position of the foot pedal lock on a foot pedal, the user's foot is substantially if not precisely in the position to continue operating the foot pedal after the pedal has been unlocked.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A foot pedal lock for a foot pedal of a musical instrument comprising:
a support comprising one or more support members extending from a base, said base configured for mounting to said foot pedal;
a swing arm comprising one or more locking members, said swing arm rotatably mounted to said support whereby said swing arm may extend by rotating to engage a retaining structure and retract by rotating to disengage said retaining structure; and
an arm biasing device configured to retract said swing arm when said swing arm is disengaged from said retaining structure.

2. The foot pedal lock of claim 1, wherein said swing arm comprises a forward extending stop.

3. The foot pedal lock of claim 1, wherein said one or more locking members comprise an angled top edge to engage said retraining structure of said foot pedal stand.

4. The foot pedal lock of claim 1, wherein said arm biasing device is a spring, said spring comprising a first arm in contact with said support and a second arm in contact with said swing arm.

5. The foot pedal lock of claim 1 further comprising:
a swing arm lock comprising a lever, said swing arm lock rotatably mounted to said support whereby said lever is positioned between said swing arm and said support;
an extension assembly extending from a back portion of said swing arm toward said lever; and
a lock biasing device configured to rotate said lever forward whereby force from said lock biasing device is applied by said lever to said extension assembly locking said swing arm in place, said lock biasing device mounted to said support.

6. The foot pedal lock of claim 6, wherein said lever is angled.

7. The foot pedal lock of claim 6, wherein said lock biasing device is magnetic.

8. The foot pedal lock of claim 6, wherein said extension assembly comprises a threaded adjustment member.

9. A foot pedal comprising:
a foot pedal having a foot pedal stand, the foot pedal stand having one or more retaining structures;
a foot pedal lock comprising:
a support attached to said foot pedal;
a pivot attached to said support;
a swing arm comprising one or more locking members, said swing arm rotatably mounted to said support by said pivot whereby said swing arm may extend by rotating about said pivot to engage a retaining structure of a foot pedal stand and retract by rotating about said pivot to disengage said retaining structure; and
an arm biasing device supported by said support and configured to retract said swing arm.

10. The foot pedal lock of claim 8, wherein said one or more retaining structures comprises a planar structure having a front face and a bottom edge whereby said bottom edge contacts said locking members when said swing arm in an extended position.

11. The foot pedal lock of claim 8, wherein said one or more retaining structures are adjustable on said foot pedal stand.

12. The foot pedal lock of claim 8, wherein said swing arm comprises a forward extending stop.

13. The foot pedal lock of claim 8, wherein said arm biasing device is a spring mounted on said pivot, said spring comprising a first arm in contact with said support and a second arm in contact with said swing arm.

14. The foot pedal lock of claim 8, wherein said one or more locking members comprise an angled top edge to engage said retraining structure of said foot pedal stand.

15. The foot pedal lock of claim 8 further comprising:
a swing arm lock comprising a lever, said swing arm lock rotatably mounted to said support by said pivot whereby said lever is positioned between said swing arm and said support;
an extension assembly extending from said swing arm toward said lever of said swing arm lock; and
a lock biasing device configured to rotate said lever forward whereby force from said lock biasing device is applied by said lever to said extension assembly locking said swing arm in place, said lock biasing device mounted to said support.

16. The foot pedal lock of claim 14, wherein said lock biasing device is magnetic.

17. A method of drumming comprising:
playing a hi-hat comprising a foot pedal, said foot pedal having a foot pedal stand with one or more retaining structures;
depressing said foot pedal to move one or more cymbals of said hi-hat;
locking said foot pedal in a locked position with a foot pedal lock by extending a swing arm of said foot pedal lock forward about a pivot until a locking member of said swing arm contacts one of said one or more retaining structures of said foot pedal stand whereby said swing arm is held in an extended position by friction between said swing arm and said retaining structure;
releasing said foot pedal from said locked position by further depressing said foot pedal to reduce said friction between said swing arm and said retaining structure; and
retracting said swing arm about said pivot with an arm biasing device.

18. The method of claim 16, wherein locking said foot pedal of said hi-hat further comprises extending said swing arm of said foot pedal lock forward about a pivot until a stop of said swing arm contacts one of said one or more retaining structures.

19. The method of claim 18 further comprising locking said swing arm in said extended position with a swing arm lock comprising a lever, said swing arm lock rotatably mounted to said pivot whereby a lock biasing device rotates said lever to contact an extension assembly of said swing arm to lock said swing arm in said extended position.

20. The method of claim 18, wherein releasing said foot pedal from said locked position further comprises rotating said lever of said swing arm lock away from said extension assembly to unlock said swing arm.
